(19) United States
(12) Patent Application Publication
(10) Pub. No.: US 2007/0195209 A1
(43) Pub. Date: Aug. 23, 2007

(54) COLOR CALIBRATING DEVICE AND ASSOCIATED SYSTEM AND METHOD

(75) Inventor: Nai-Sheng Cheng, Hsinchu (TW)

Correspondence Address: KIRTON AND MCCONKIE, 60 EAST SOUTH TEMPLE,, SUITE 1800, SALT LAKE CITY, UT, 84111, US

(73) Assignee: MSTAR SEMICONDUCTOR, INC., Hsinchu hsien (TW)

(21) Appl. No.: 11/608,664

(22) Filed: Dec. 8, 2006

(30) Foreign Application Priority Data
Feb. 20, 2006 (TW) 095105663

(51) Int. Cl. H04N 3/26

(52) U.S. Cl. 348/745

(57) ABSTRACT

A color calibrating device and associated system and method are used with an image generating device and a projector. The projector projects a first image in response to a first display signal outputted by the image generating device. The color calibrating method includes steps of: capturing the first image; generating a color calibrating function according to the first display signal and the captured image; and calibrating the display signal outputted by the image generating device according to the color calibrating function for projecting by the projector.

### FIELD OF THE INVENTION

The present invention relates to a color calibrating device and method, and more particularly to a color calibrating device and method used between an image generating device and a projector.

### BACKGROUND OF THE INVENTION

FIG. 1 illustrates a function block diagram of a conventional presentation system. The presentation system includes a computer system 10 having a monitor 101 and connected to a projector 11. Display signals generated by the computer system 10 can be displayed by the projector 11 in an analog or digital form in addition to the monitor 101. The projector 11, once receiving a display signal from the computer system 10, transforms the display signal into light beams to be projected on a screen (not shown).

Generally, the monitor 101 is a Liquid Crystal Display (LCD) monitor or a Cathode Ray Tube (CRT) monitor. However, the displaying principle and displaying color features thereof are different from those of the projector 11. Therefore, there exists visible color difference between these two displaying means when the same image signal is displayed. As a result, the presentation system using the projector 11 can not reveal the color effect of image created or edited via the monitor 101. Such a problem is critical in some presentations involving in color-sensitive material such as posters or fashion designs.

### SUMMARY OF THE INVENTION

Therefore, the present invention provides a color calibrating device and a color calibrating method applied in an image generating device to make the images shown on a display and a projector consistent with each other.

The invention provides a color calibrating device applied between an image generating device and a display device thereon a first image according to a first display signal, comprising: an image sensor for capturing the first image and transforming the first image into sensing data; and, a color calibrator electrically connected to the image sensor, the image generating device, and the display device; wherein the color calibrator determines a color calibrating function according to the first display signal and the sensing data for calibrating a second display signal transmitted from the image generating device to obtain a calibrated display signal.

The invention also provides an image displaying system adapted to be used with an image generating device, comprising: a display device for displaying a first image according to a first display signal; an image sensor for capturing the first image and transforming the first image to sensing data; and, a color calibrator electrically connected between the image generating device and the image sensor for determining a color calibrating function according to the first display signal and the sensing data, and for color-calibrating a second display signal generated by the image generating device to generate a calibrated display signal to be displayed by the display device.

The invention further provides a color calibrating method for calibrating a color of an image displayed on a display device, the method comprising steps of: displaying a first image on the display device according to a first display signal; capturing the first image and transforming the first image into sensing data; determining a color calibrating function according to the first display signal and the sensing data; color-calibrating a second display signal generated by an image displaying device to a calibrated display signal; and, displaying a second image on the display device according to the calibrated display signal.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram illustrating a conventional presentation system;

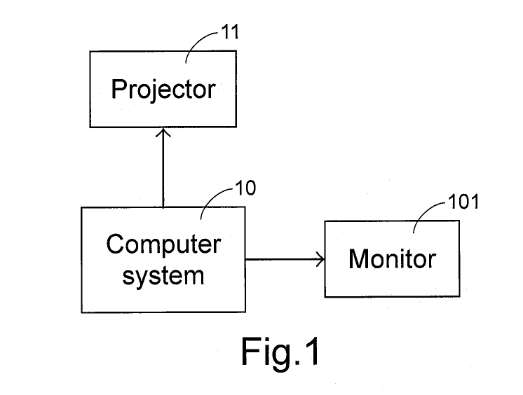

FIG. 2(a) is a block diagram illustrating a color calibrating device according to an embodiment of the invention;

FIG. 2(b) is a flowchart of a color calibrating method according to a first embodiment of the invention;

FIG. 2(c) is a flowchart of a modified color calibrating method according to an embodiment of the invention;

FIG. 2(d) is a flowchart of another modified color calibrating method according to an embodiment of the invention;

FIG. 3(a) is a block diagram illustrating a color calibrating device according to an embodiment of the invention;

FIG. 3(b) is a flowchart of a color calibrating method according to an embodiment of the invention;

FIG. 4(a) is a block diagram illustrating a digital image regenerating system according to an embodiment of the invention;

FIG. 4(b) is a block diagram illustrating a projector system according to an embodiment of the invention;

FIG. 5(a) is a flowchart of a color calibrating method according to a further embodiment of the invention; and

FIG. 5(b) is a flowchart of a color calibrating method according to a further embodiment of the invention.

### DETAILED DESCRIPTION OF PREFERRED EMBODIMENTS

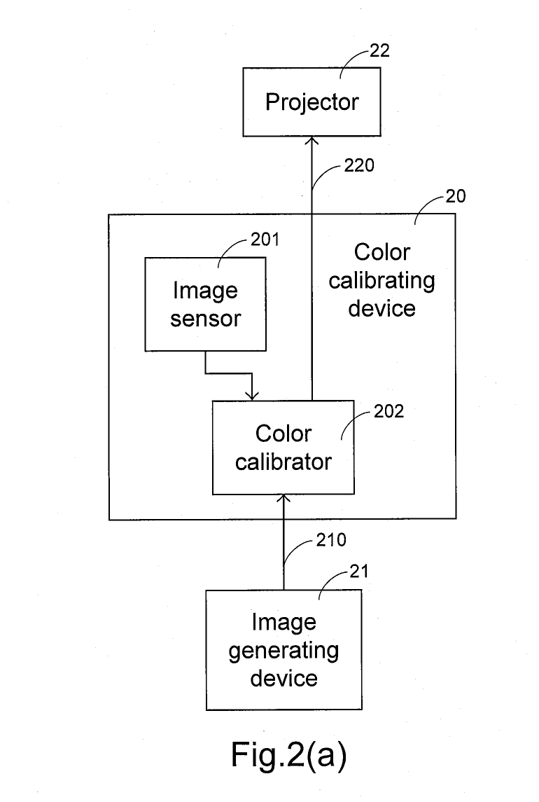

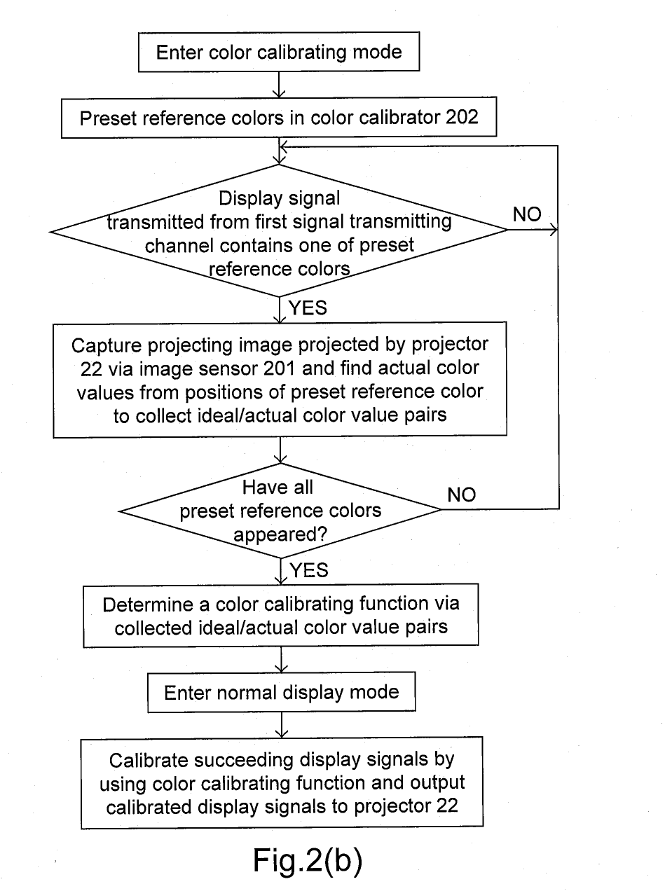

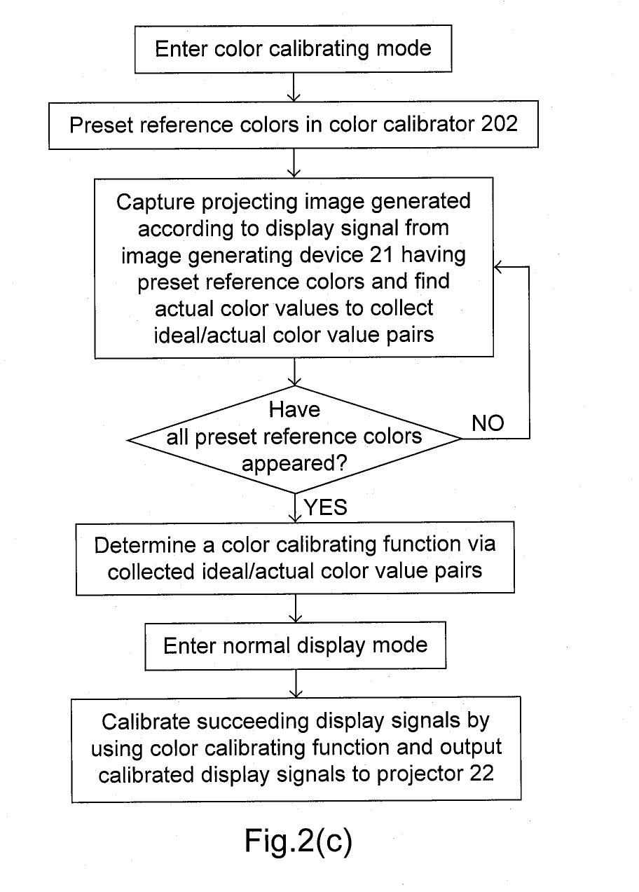

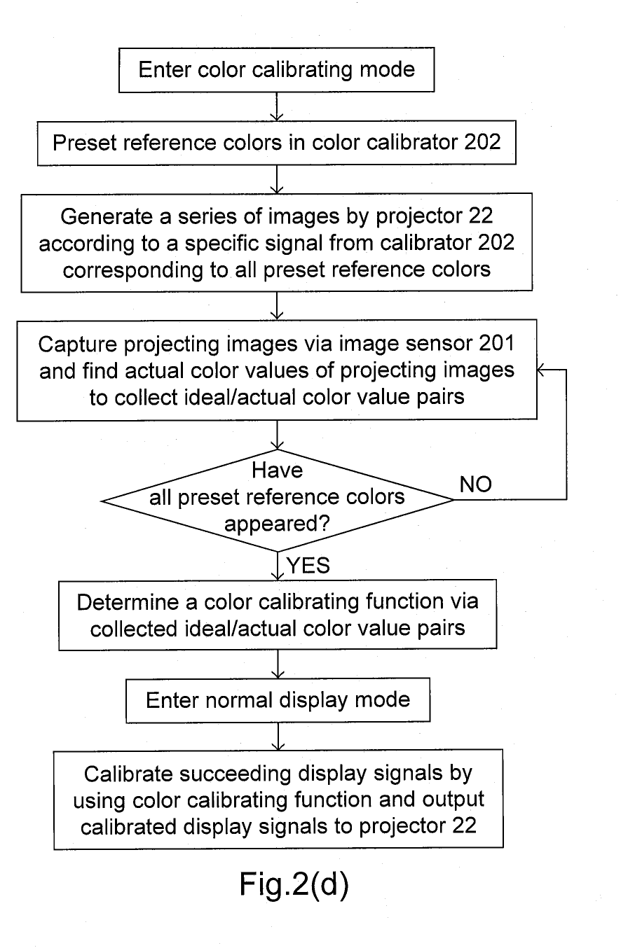

FIG. 2(a) illustrates a block diagram of a color calibrating device 20 according to a first embodiment of the invention. The color calibrating device 20 can be applied between an image generating device 21 and a projector 22. The projector 22 generates a projecting image on a screen (not shown) according to a display signal provided by the image generating device 21. The projector 22 is an illustrated example and can be replaced by any image display device such as a CRT display, an LCD or a plasma display . . . etc.

The color calibrating device 20, capable of operating under a color calibrating mode and a normal display mode, includes an image sensor 201 and a color calibrator 202. The image sensor 201 can be a Charge Coupled Device (CCD) or a Complementary Metal Oxide Semiconductor (CMOS) sensor. In the color calibrating mode, the image sensor 201 captures the projecting image projected by the projector 22 and transforms the captured projecting image into sensing data having a plurality of pixels, wherein each of the pixels has a specific color value and a coordinate value. The color calibrator 202 generates a color calibrating function according to the display signal outputted from the image generating device 21 and the sensing data outputted from the image sensor 201. Once the calibrating function is generated, the color calibrating device 20 enters to the normal display mode. The succeeding display signal outputted from the image generating device 21 will be calibrated by using the color calibrating function before it is transmitted to the projector 22. Therefore, the actual projecting image displayed on the screen according to the calibrated display signal shows the ideal color to the audiences.

In this embodiment, the image generating device 21 keeps on generating display signals, as normal projection, to the projector 22 in the color calibrating mode. The display signals are transmitted to the color calibrator 202 via a first signal transmitting channel 210. The first signal transmitting channel 210 can be, for example, digital RGB signal lines or analog RGB signal lines. It should be noted that the color calibrator 202 cannot predict the content of the incoming display signals generated by the image generating device 21. Preferably, a plurality of reference color values are preset in the color calibrator 202. Accordingly, the display signals transmitted from the first signal transmitting channel 210 will be kept on monitored to see if any of the reference color values appears. Once any of the reference color values appears, the associated coordinate will be identified by the color calibrator 202. Meanwhile, the projecting image projected by the projector 22 will be captured by the image sensor 201, and an actual color value of the pixel corresponding to a position of the reference color value identified earlier by the color calibrator 202 will be obtained. That is to say, the actual color value of the projecting image at the position of the reference color value on the screen is obtained and can be used in color calibration. Therefore, an ideal/actual color value pair is collected by the color calibrator 202. After a plurality of ideal/actual color value pairs of all reference colors have been collected, these ideal/actual color value pairs determine a color calibrating function. Consequently, in the normal display mode, the succeeding display signals transmitted into the color calibrator 202 will be calibrated by the color calibrating function, and then the calibrated display signals will be further transmitted to the projector 22 via a second signal transmitting channel 220 connected between the color calibrator 202 and the projector 22. The second signal transmitting channel 220 can be, for example, digital RGB signal lines or analog RGB signal lines. The flowchart of the above-mentioned process is shown in FIG. 2(b).

For example, N reference color values (R1, G1, B1), (R2, G2, B2) . . . (RN, GN, BN) can be represented as a matrix A, and preset in the system. The color calibrator 202 monitors the display signals transmitted on first signal transmitting channel 210, and collects the actual color values from the projecting image captured by the image sensor 201. After all the preset reference color values have appeared, N actual color values (R1′, G1′, B1′), (R2′, G2′, B2′) . . . (RN′, GN′, BN′), represented as a matrix A′, are collected. According to matrices A and A′, a first color transformation matrix Ma is obtained. The relationship among matrices A, A′, and Ma is:

A*Ma=A′, i.e. A=A′*Ma⁻¹.

The transformation matrix Ma represents the color deviation of the projector 22. For compensating such a deviation, the display signals transmitted from the first signal transmitting channel 210 preferably requires a second color transformation matrix Mb to transform A into another compensated matrix A″, i.e.

A″=A*Mb.

Accordingly, the compensated matrix A″ can be transformed by the projector 22 again and adjusted to the ideal color values:

A″*Ma=A

Now, replace A″ by A*Mb to obtain:

A*Mb*Ma=A; and thus

Mb=Ma⁻¹

As a consequence, the color values of all pixels transmitted to the color calibrator 202 will be compensated by the color calibrating function, such as the second color transformation matrix Mb, before being transmitted to the projector 22. Accordingly, the projected image will have color values closer to the original desired. The computations mentioned above can be performed by a microprocessor (not shown) in the color calibrator 202 or other equivalent calculating unit. The second color transformation matrix Mb can be varied in accordance with the kinds and amount of the preset reference color values. Therefore, for different applications such as human figures, scenic photos, or merchandise pictures, the second color transformation matrix Mb can be adjusted by changing the kinds and amount of the preset reference color values.

A modified color calibrating method capable of being applied on the system of the first embodiment is shown in FIG. 2(c). In this modified method, the image generating device 21 automatically generates a display signal corresponding to all preset reference color values in the color calibrator 202, and transmits the display signal with these reference color values to the color calibrating device 20. Since there is no need to wait for the occasional appearance of the reference color values, the modified method is faster than the above-mentioned method. The task of generating and transmitting the preset reference color values can be preformed by, for example, executing a program.

Another modified method which can be applied on the system of the first embodiment is shown in FIG. 2(d). In this modified method, there is no need to generate and transmit the display signal of the preset reference color values by the image generating device 21. Instead, the color calibrator 202 generates a specific signal corresponding to all preset reference color values by itself and transmits the specific signal to the projector 22. Image data are then projected by the projector 22 according to the specific signal and then captured by the image sensor 201 to obtain ideal/actual color value pairs. Accordingly, the display signal can be calibrated before being projected, and then the ideal projecting image will be obtained.

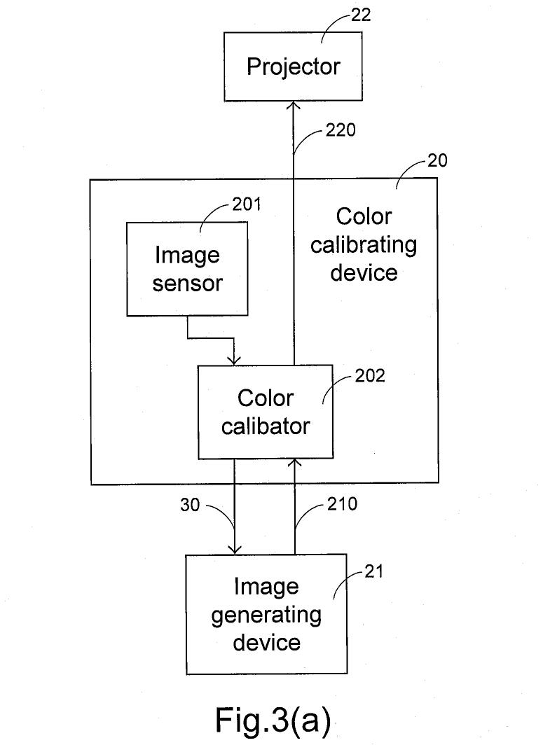

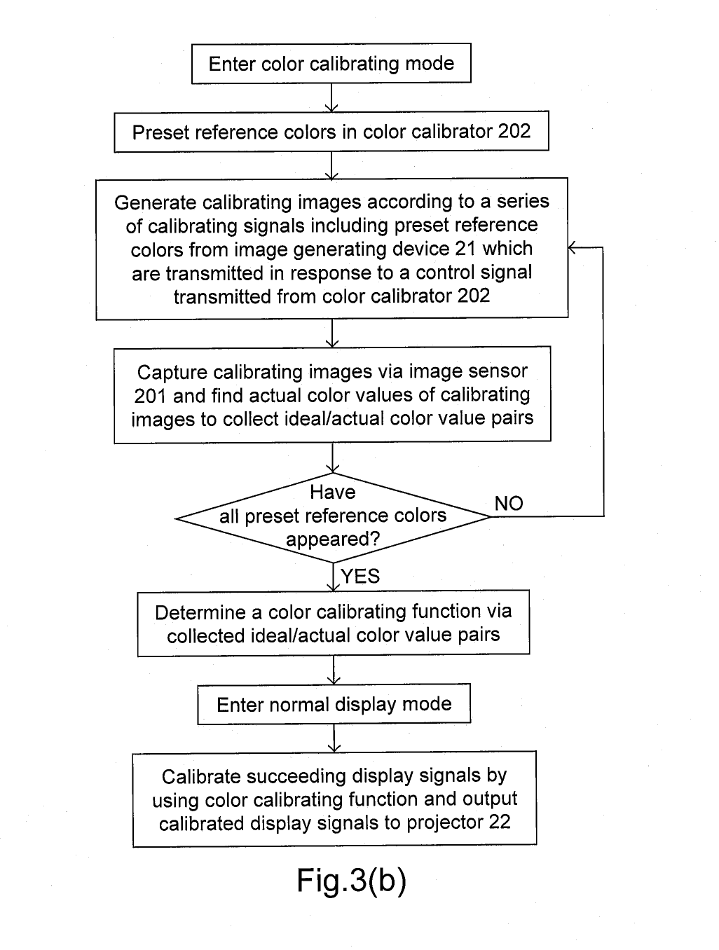

FIG. 3(a) illustrates a block diagram of the color calibrating device 20 according to a second embodiment of the invention. All components of the second embodiment are similar to those of the first embodiment except the third signal transmitting channel 30. The third signal transmitting channel 30 can be a Universal Serial Bus (USB) or any other data transmitting channel. The third signal transmitting channel 30 transmits a control signal from the color calibrator 202 to the image generating device 21 for requesting the image generating device 21 to output calibrating data associated with at least one calibrating image(s). These calibrating images include a plurality of reference color values preset in the color calibrator 202. Since the calibrating images are generated under the request from the color calibrator 202, there is no need to monitor the signal outputting via the first signal transmitting channel 210. The flowchart of calibrating method associated with the second embodiment is shown in FIG. 3(b). When the color calibrator 202 is powered on, it enters to the color calibrating mode. Meanwhile, a control signal is generated and transmitted from the color calibrator 202 to the image generating device 21 to request calibrating data corresponding to calibrating image(s). Then a plurality of calibrating images are generated according to the calibrating data from the image generating device 21 and projected by the projector 22, and then captured by the image sensor 201 to generate sensing data having actual color values corresponding to the series of calibrating images for feedback calibration similar to what have been disclosed above. After that, the second color transformation matrix Mb is determined, the image capturing operated by the image sensor 201 stops, and then the system enters to the normal display mode. The succeeding display signal generated by the image generating device 21 will be calibrated by the second color transformation matrix Mb before transmitted to the projector 22 to be projected. Accordingly, the color values of the projected image have been compensated and thus an ideal image is obtained. This embodiment has a faster calibrating speed compared with the methods which need to wait for collecting the occasionally occurred preset reference color values from the signal generated by the image generating device 21. Furthermore, through the control signals transmitted by the third signal transmitting channel 30, the image generating device 21 can be well coordinated with the color calibrator 202. Furthermore, instead of two independent transmitting lines, the first signal transmitting channel 210 and the third signal transmitting channel 30 can be implemented by a single USB line.

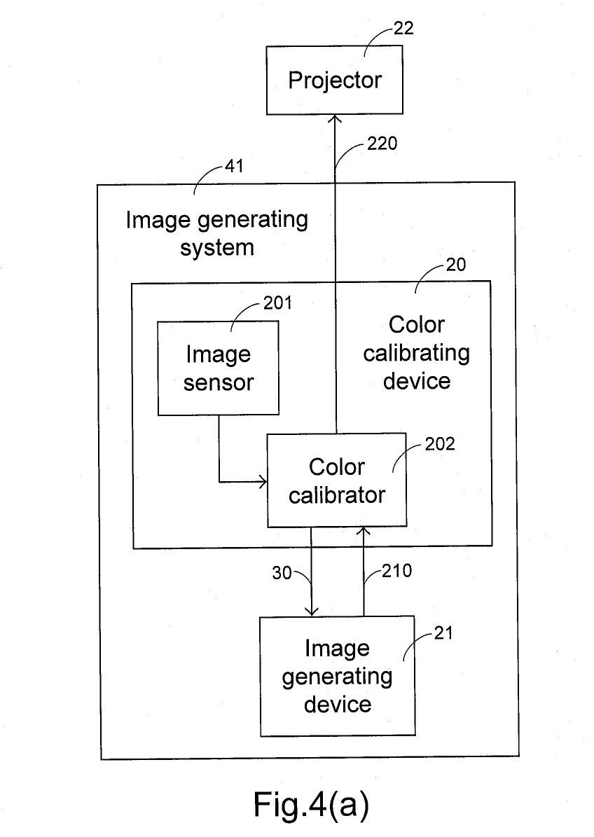

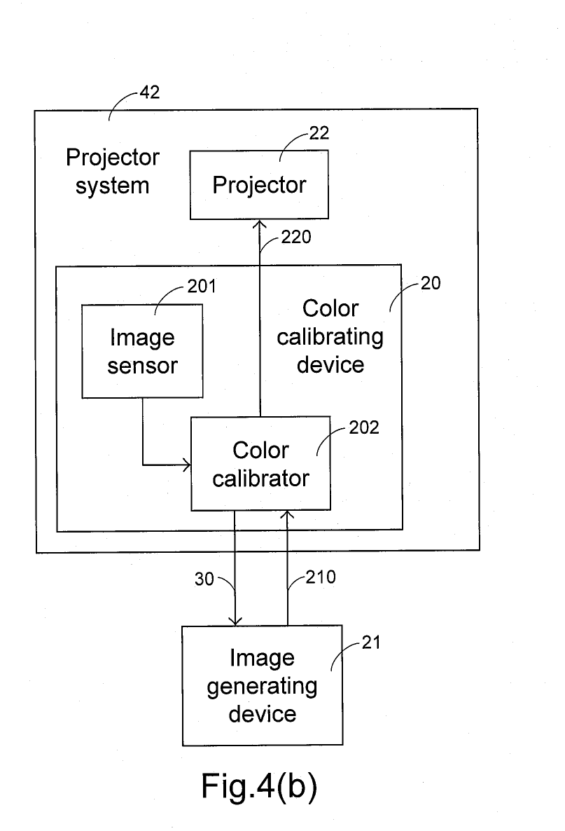

The color calibrating device 20 illustrated in FIG. 2(a) and FIG. 3(a) can be installed within a housing independent from the image generating device 21 and the projector 22. It can be coupled to the image generating device 21 and the projector 22 through detachable cables or wireless signal transmitting channels. The color calibrating device 20 is detachable from the image generating device 21 and the projector 22 and thus can be applied flexibly to different systems or different environments. For example, the color calibrating device 20 can be applied to a home theater system or a desktop computer system. It is also possible to integrate the color calibrating device 20 into a housing of an image generating system 41 shown in FIG. 4(a), or a housing of a projector system 42 shown in FIG. 4(b). The projector 22 can also be replaced by any other display device. The above-mentioned diversified embodiments should be all within the scope of the invention.

The above-mentioned calibrating embodiments should be performed under a condition that both the image generating device 21 and the image sensor 201 must have been color-calibrated before they are shipped. Even if the image generating device 21 is not well-calibrated in advance, desired calibration can still be performed according to the following embodiments of the present invention.

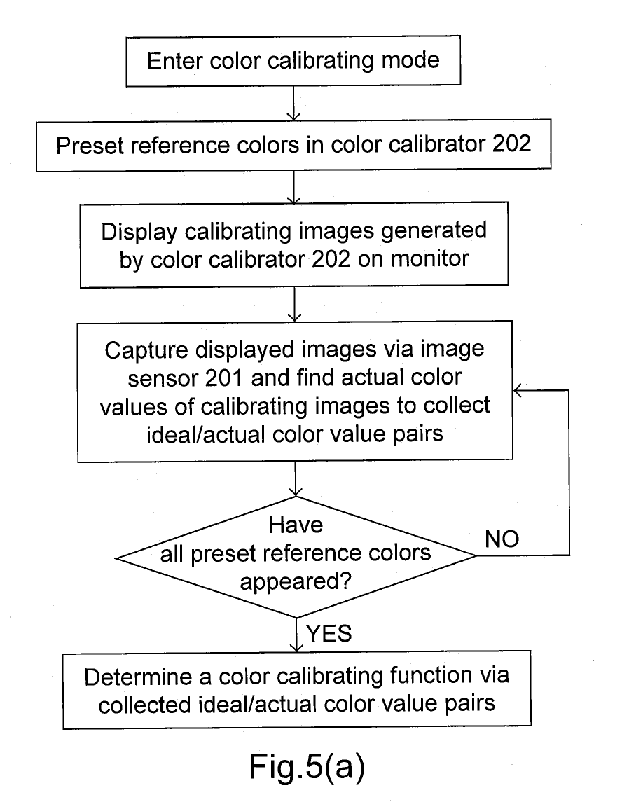

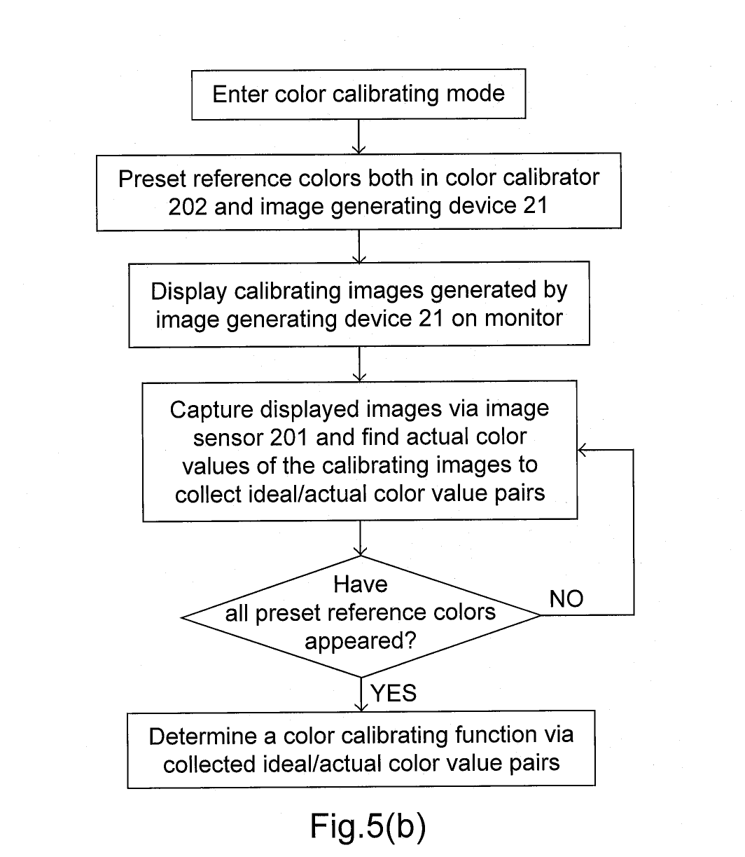

FIG. 5(a) illustrates the first method. A plurality of color values can be preset in the color calibrator 202. The color calibrator 202 generates at least one calibrating image according to the preset color values to be displayed on a monitor (not shown) of the image generating device 21. The image sensor 201 is made to face the monitor of the image generating device 21, such as a notebook, so that the image displayed on the monitor can be captured and calibrating data can be obtained by the color calibrating device 20. After then, the color calibrating device 20 sends the calibrating data through the third signal transmitting channel 30 to the image generating device 21 to be displayed on the monitor. Applying a process similar to what has been described above, the color transformation matrix Mc of the monitor is then obtained. Alternatively, the present invention can further calibrate the color difference between the monitor of the notebook and the projector 22. Normally, the monitor of the notebook can display colors more correctly than the projector 22, with a quite stable quality. Therefore, a person can refer to the image on the monitor as a reference color source to calibrate the projector 22. The image sensor 201 can be made to face the monitor and the projector 22 to capture images, respectively. The color transformation matrix Mc can be determined by comparing the captured images of the monitor and the projector 22.

The second method, as shown in FIG. 5(b), is similar to the first method but that the calibrating data are not generated by the color calibrating device 20. Instead, the calibrating data are generated by the image generating device 21. The calibrating images associate with the reference color values being preset in both the color calibrating device 20 and the image generating device 21. The auto-generated calibrating images are then automatically displayed on the monitor 211. Accordingly, through the color-calibrating mechanism mentioned above, a third color transformation matrix Mc of the monitor 211 can be determined and the third color transformation matrix Mc can be seen as the color calibrating function applied to the color calibrating device 20.

To sum up, a color calibrating device 20 is preferably applied between the conventional image generating device 21 and the projector 22. The projected image provides color calibration information via a color feedback calibrating mechanism. The color calibration can be performed by processes disclosed in FIG. 2(b), FIG. 2(c), FIG. 2(d) and/or FIG. 3(b). If the image generating device is not color-calibrated, the color-calibrating process shown in FIG. 5(a) or FIG. 5(b) is needed to be executed before executing the calibration process indicated in FIG. 2(b), FIG. 2(c), or FIG. 2(d) and/or FIG. 3(b). Accordingly, the projector 22 is capable of projecting images having color values close to the user's desire.

The image generating device 21 could be a computer system or a digital video disc drive equipped with a display. The image sensor 201 could be a charge coupled device or a complementary metal oxide semiconductor sensor coupled with lens. The projector 22 could be a video or a multimedia projector, etc. Furthermore, the invention could be applied not only to the projector system, but also a home theater system, or other display systems.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A color calibrating device applied between an image generating device and a display device which displays a first image according to a first display signal, comprising:
an image sensor for capturing the first image and transforming the first image into sensing data; and
a color calibrator electrically connected to the image sensor, the image generating device, and the display device;
wherein the color calibrator determines a color calibrating function according to the first display signal and the sensing data for calibrating a second display signal transmitted from the image generating device to obtain a calibrated display signal.

2. The color calibrating device according to claim 1, wherein the display device displays a second image according to the calibrated display signal.

3. The color calibrating device according to claim 1, wherein the first display signal includes a plurality of pixels each of which has an ideal color value, the sensing data includes a plurality of sensed pixels corresponding to the plurality of pixels associated with the first display signal, each of the plurality of sensed pixels having an actual color value, and the color calibrator identifies the sensed pixels to obtain a plurality of ideal/actual color value pairs.

4. The color calibrating device according to claim 1, wherein the color calibrator couples with the image generating device through a signal transmitting channel to transmit a control signal from the calibrator to the image generating device to generate the first display signal.

5. The color calibrating device according to claim 1, wherein the image generating device is connected to a display for displaying thereon a third image according to the first display signal, and the image sensor is capable of capturing the third image for the color calibrator to calibrate a fourth image to be displayed on the display.

6. An image displaying system adapted to be used with an image generating device, comprising:
a display device for displaying a first image according to a first display signal;
an image sensor for capturing the first image and transforming the first image to sensing data; and
a color calibrator electrically connected between the image generating device and the image sensor for determining a color calibrating function according to the first display signal and the sensing data, and for color-calibrating a second display signal generated by the image generating device to generate a calibrated display signal to be displayed by the display device.

7. The image displaying system according to claim 6, wherein the first display signal is generated by the color calibrator according to a plurality of preset reference color values.

8. The image displaying system according to claim 6, wherein a third signal transmitting channel is connected between the image generating device and the color calibrator for transmitting a control signal by the color calibrator to the image generating device to generate the first display signal.

9. The image displaying system according to claim 8, wherein the image generating device includes a monitor, and a color calibrating signal is transmitted from the color calibrator to the image generating device through the third signal transmitting channel for generating at least one calibrating image on the monitor to be captured by the image sensor to determine the color calibrating function for calibrating the second display signal.

10. The image displaying system according to claim 6, wherein the display device is a projector.

11. The image displaying system according to claim 6, wherein the display device is a home theater system.

12. A color calibrating method for calibrating a color of an image displayed by a display device, the method comprising steps of:
displaying a first image according to a first display signal;
capturing the first image and transforming the first image into sensing data;
determining a color calibrating function according to the sensing data;
color-calibrating a second display signal generated by an image displaying device to a calibrated display signal by using the color calibrating function; and
displaying a second image according to the calibrated display signal.

13. The color calibrating method according to claim 12, wherein the display device is a projector.

14. The color calibrating method according to claim 12, wherein the color calibrating function is determined by a color calibrator.

15. The color calibrating method according to claim 12, further includes a step before displaying the first image:
presetting a plurality of reference color values in a color calibrator.

16. The color calibrating method according to claim 12, wherein the first display signal includes a plurality of pixels and each of pixels has an ideal color value and a coordinate value representing a position located on the first image, the sensing data includes a plurality of sensed pixels, each of the plurality of sensed pixels includes an actual color value, and the method further includes a step of:
identifying the plurality of sensed pixels to obtain a plurality of ideal/actual color value pairs.

17. The color calibrating method according to claim 12, wherein the first display signal associates with at least one calibrating image, each calibrating image associates with one of a plurality of preset color values, and the method further comprises steps of:
sensing the at least one calibrating image to obtain a plurality of actual color values; and
determining the color calibrating according to the preset color values and the actual color values.

18. The color calibrating method according to claim 12, wherein the determining step determines the color calibrating function according to the first display signal and the sensing data.

19. The color calibrating method according to claim 12, wherein the image generating device includes a monitor, and the method further includes steps of:
displaying a calibrating image via the monitor according to a calibrating signal;
capturing the calibrating image and transforming the calibrating image into sensing data; and
determining the color calibrating function according to the calibrating signal and the sensing data.

20. The color calibrating method according to claim 19, wherein the calibrating image is generated by the image generating device.

21. The color calibrating method according to claim 19, wherein the calibrating signal is generated by the color calibrator.
